(19) United States
(12) Patent Application Publication
(10) Pub. No.: US 2007/0077522 A1
(43) Pub. Date: Apr. 5, 2007

(54) Optical recording medium, method for reproducing information and optical information reproducing apparatus

(75) Inventors: Yasuhiro Satoh, Yokohama-shi (JP); Sumio Ashida, Yokohama-shi (JP); Masatoshi Hirono, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/526,863

(22) Filed: Sep. 26, 2006

(30) Foreign Application Priority Data
Sep. 29, 2005 (JP) P2005-285589

(51) Int. Cl. G11B 7/24

(52) U.S. Cl. 430/270.11

(57) ABSTRACT

An optical recording medium includes a plurality of information layers and an absorption variation layer. Information is recorded in the plurality of information layers. The absorption variation layer is disposed between respective two adjacent information layers. Light transmittance of each absorption variation layer varies in accordance with light applied thereto.

### CROSS-REFERENCE TO RELATED APPLICATIONS

This application is based upon and claims the benefit of priority from the Japanese Patent Application No.2005-285589 filed on Sep. 29, 2005; the entire contents of which are incorporated herein by reference.

### BACKGROUND OF THE INVENTION

1. Field of the Invention

The present invention relates to an optical recording medium, an optical information reproducing method and an optical information reproducing apparatus, in which information can be recorded and reproduced when light is applied onto the optical recording medium.

2. Description of the Related Art

Optical recording media such as a CD and a DVD have become widespread as data storage media for storing audio data, image data, motion image data, etc. The optical recording media have been put into practice use as read-only media and rewritable media. A multilayer recording medium having recording layers has been proposed as a measure to improve the recording capacity of these media.

Of the multi layer recording medium, a single-side double-layer recording medium is implemented by making a recording layer near to a light incidence portion in the multilayer recording medium to be semitransparent (see US 2002/0168588 A). To reproduce the single-side double-layer medium, reproduction light is applied onto one surface of the single-side double-layer medium so that two different recording layers can be accessed. Accordingly, the single-side double-layer recording medium has an advantage that the two recording layers can be accessed in a short time.

Incidentally, when a recording layer near to a light incidence portion is to be reproduced, that is, when a recording layer near to a light incidence portion is selected as a reproduction layer, light is focused on the recording layer near to the light incidence portion. On this occasion, a recording layer far from the light incidence portion serves as a non-reproduction layer. A part of light applied on the recording layer selected as a reproduction layer may however be transmitted through the reproduction layer, so that the part of light may reach the recording layer, which serves as a non-reproduction layer far from the light incidence portion. The light, which has reached the recording layer, is reflected and returned to a pickup system while mixed with reflected light from the reproduction layer. For this reason, reproducing process may be affected by grooves, pits, recording marks etc. in the recording layer far from the light incidence portion.

As described above, in a single-side double-layer medium according to, for example, US 2002/0168588 A, when a recording layer near to a light incidence portion is selected as a reproduction layer, a reflected light component from a non-focused recording layer far from the light incidence portion cannot be removed. For this reason, this reflected light component may become noise in a reflected light component from the reproduction layer, so that S/N is worsened. As a result, the error rate of a reproduction signal cannot be reduced sufficiently.

### BRIEF SUMMARY OF THE INVENTION

The invention has been made under these circumstances and provides an optical recording medium having information layers, a method for reproducing optical information and an optical information reproducing apparatus, which are effective in reproducing information recorded in a selected reproduction layer independently with high accuracy without interference with another information layer not selected at the time of reproduction.

According to an aspect of the invention, an optical recording medium includes a plurality of information layers and an absorption variation layer. Information is recorded in the plurality of information layers. The absorption variation layer is disposed between respective two adjacent information layers. Light transmittance of each absorption variation layer varies in accordance with light applied thereto.

According to another aspect of the invention, a method reproduces the information recorded in the above optical recording medium. The method includes applying absorption variation light onto the optical recording medium to change the light transmittance of the absorption variation layer; and applying reproduction light to reproduce the information recorded in the information layers of the optical recording medium.

According to a still another aspect of the invention, an optical information reproducing apparatus includes the optical recording medium, a first light emission device and a second light emission device. The optical recording medium includes a plurality of information layers and an absorption variation layer. Information is recorded in the plurality of information layers. The absorption variation layer is disposed between respective two adjacent information layers. Light transmittance of each absorption variation layer varies in accordance with light applied thereto. The first light emission device is configured to emit absorption variation light onto the optical recording medium to change light transmittance of the absorption variation layer. The second light emission device is configured to emit reproduction light to reproduce the information recorded in the information layers of the optical recording medium.

According to the above configuration, information recoded in a selected reproduction layer can be reproduced independently with high accuracy without interference with another information layer not selected at the time of reproduction even in the case where the number of information layers including recording layers respectively is increased. It is possible to provide an optical recording medium with a large recording capacity without crosstalk between a reproduction layer and a non-reproduction layer.

### BRIEF DESCRIPTION OF THE DRAWINGS

FIG. 1 is a sectional view of an optical recording medium showing a first embodiment of the invention;

FIG. 2 is a conceptual view showing temporal change in transmittance due to thermochromism;

FIG. 3 is a conceptual view showing optical constant spectra in thermochromism of ZnO;

FIG. 4 is a conceptual view showing temporal change in transmittance due to saturable absorption;

FIG. 5 is a sectional view of disk A for explaining Example 1 of the invention;

FIG. 6 is a conceptual view showing a method of playing back an information layer in the Example of the invention;

FIG. 7 is a sectional view of disk B for explaining Example 2 of the invention;

FIG. 8 is a conceptual view showing a method of playing back an information layer in the Example of the invention;

FIG. 9 is a sectional view of disk C for explaining Example 3 of the invention;

FIG. 10 is a sectional view of disk D for explaining Comparative Example 1 of the invention;

FIG. 11 is a sectional view of disk E for explaining Comparative Example 2 of the invention;

FIG. 12 is a sectional view of disk F for explaining Comparative Example 3 of the invention;

FIG. 13 is a sectional view of disk G for explaining a second embodiment of the invention and Example 4 of the invention;

FIG. 14 is a sectional view of disk H for explaining Comparative Example 4 of the invention;

FIG. 15 is a sectional view of disk I for explaining a third embodiment of the invention and Example 5 of the invention;

FIG. 16 is a conceptual view showing a method of playing back an information layer in Example 5 of the invention; and

FIG. 17 is a sectional view of an optical recording medium showing a fourth embodiment of the invention.

### DETAILED DESCRIPTION OF EMBODIMENTS OF THE INVENTION

Exemplary embodiments of the invention will be described below with reference to the drawings. In the following description concerned with the drawings, the same or like parts are referred to by the same or like numerals. Incidentally, the drawings are schematic, so that it should be noted that the configuration shown in the drawings as to the relation between thickness and planar size, thickness ratios of respective layers, etc. is different from the actual one. Therefore, specific thicknesses and sizes are to be judged in consideration of the following description. It is a matter of course that portions different in the relation between sizes and the ratios thereof are contained in the drawings.

### First Embodiment

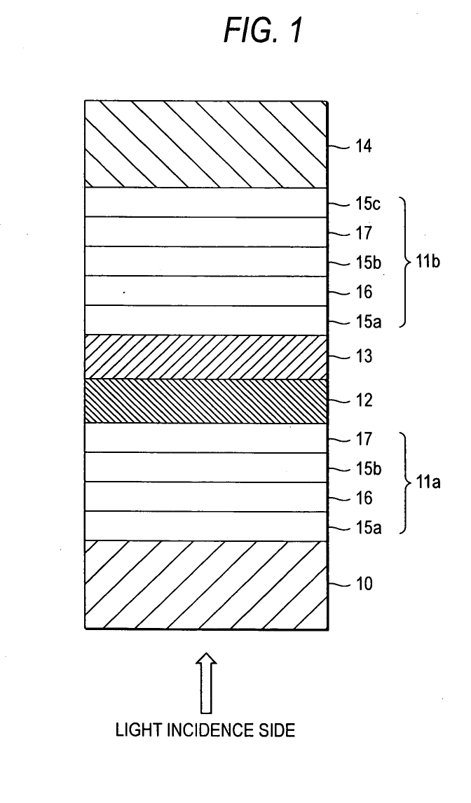

As shown in FIG. 1, an optical recording medium according to a first embodiment of the invention is formed as a single-side double-layer rewritable optical recording medium which includes a first substrate 10, a first information layer 11a, an absorption variation layer 12, an intermediate layer 13, a second information layer 11b and a second substrate 14 laminated successively when viewed from a light incidence side. The first information layer 11a has a protective layer 15a, a recording layer 16, a protective layer 15b and a reflection layer 17 laminated successively when viewed from the light incidence side. The second information layer 11b has a protective layer 15a, a recording layer 16, a protective layer 15b, a reflection layer 17 and a protective layer 15c laminated successively when viewed from the light incidence side.

The first substrate 10 is made of a material which is transparent to the wavelength of reproduction light so as not to disturb incidence of light onto the first and second information layers 11a and 11b. The material of the first substrate 10 is not particularly limited. Examples of the material of the first substrate 10 include: thermoplastic transparent resins (plastics) such as polycarbonate, amorphous polyolefin, thermoplastic polyimide, PET (polyethylene terephthalate), PEN (polyether-nitrile), PES (polyether-sulfone), etc.; thermosetting transparent resins such as thermosetting polyimide, ultraviolet-curing acrylic resin, etc.; and combinations thereof. The thickness of the first substrate 10 is not particularly limited but preferably selected to be in a range of from about 0.1 mm to about 1.2 mm.

The material of the protective layers 15a, 15b and 15c is not particularly limited. Each protective layer is made of a material which is transparent to the wavelength of reproduction light and has a high refractive index for performing optical interference. Specifically, it is preferable that the material contains at least one kind of dielectric selected from the group consisting of Al₂O₃, AlN, ZnS, GeN, GeCrN, CeO, SiO, SiO₂, Cr₂O₃, Ta₂O₅, SiN and SiC, as a main component. It is further preferable that the material contains a dielectric of ZnS.SiO₂ as a main component.

Each of the recording layers 16 is made of a material which has an optical constant varying to form a recording mark region when a laser beam is applied on the material and which has such property that reproduction light reflectance of the recording mark region is widely different from that of the other region. The material of the recording layers 16 is not particularly limited. Examples of the material of the recording layers 16 include: a phase change recording film using variation in optical constant due to crystal-to-amorphous phase change in the recording mark region; an eutectic crystal recording film exhibiting reflectance changed in such a manner that an eutectic alloy of elements constituting two layers is formed as a recording mark; and a geometric change recording film using variation in reflectance due to geometric change (such as perforating, pitting, bubbling, and change in surface shape) in the recording mark region formed in the recording layer.

Examples of the material of the phase change recording film include: Ge—Bi—Te alloy; Sb—Te alloy; Ge—Te alloy; Ge—Sb—Te alloy; In—Sb—Te alloy; Ag—In—Sb—Te alloy; In—Sb—Sn alloy; TeOx; and TeOx containing Pd, Ge, Sb, Sn, Pb or the like as additives.

The eutectic crystal recording film has a recording layer made of an alloy containing at least one kind of element selected from the element group consisting of (Ge, Si and Sn) and at least one kind of element selected from the element group consisting of (Au, Ag, Al and Cu) as main components or has a recording layer made of the two element groups laminated respectively. Examples of the eutectic crystal recording method include a method using variation in reflectance by applying a laser beam to the alloy to change atomic arrangement of the alloy, and a method of alloying a portion irradiated with a laser beam.

Examples of the material of the geometric change recording film include: a Te film; and a Te film containing Pb, Sn C, Se or I as additives.

An example of the material of the reflection layer 17 includes an alloy containing Ag, Al, Au or Cu as a main component.

The absorption variation layer 12 includes a material which, exhibits transmittance varying with respect to the wavelength of reproduction light when absorption variation light is applied on the absorption variation layer 12. Examples of the material of the absorption variation layer 12 include a thermochromic material, a saturable absorption material, and a photochromic material.

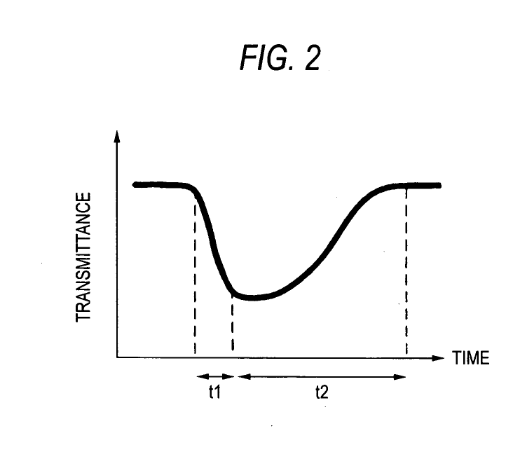

The thermochromic material is a material whose transmittance varies in accordance with change in chemical structure when the material absorbs heat. For example, the thermochromic material shows a tendency for transmitted light intensity to change in accordance with the time of application of absorption variation light as shown in FIG. 2. Examples of the thermochromic material include: inorganic thermochromic substances such as metal oxide; and organic thermochromic substances such as lactone or fluorane containing alkali, leuko pigment containing organic acid, etc. Preferably, metal oxide having absorption edge wavelength transmittance varying in accordance with change in forbidden band due to the temperature is used as the thermochromic material. Such metal oxide is excellent in durability because the composition or shape of the metal oxide hardly changes even if change in chemical structure due to change in temperature is repeated. Specific examples of the metal oxide include ZnO, SnO₂, CeO₂, NiO₂, In₂O₃, TiO₂, Ta₂O₅, VO₂, SrTiO₃, etc. When, for example, the wavelength of reproduction light is in a range of from 380 nm to 415 nm (e.g. 405 nm), ZnO (zinc oxide) having an absorption edge wavelength near 375 nm on a short wave side at ordinary temperature is particularly preferably used as the absorption variation layer. Furthermore, for example, the themochromic material may have an absorption edge wavelength in a range of 350 nm to 450 nm, a range of 600 nm to 700 nm or a range of 730 nm to 850 nm.

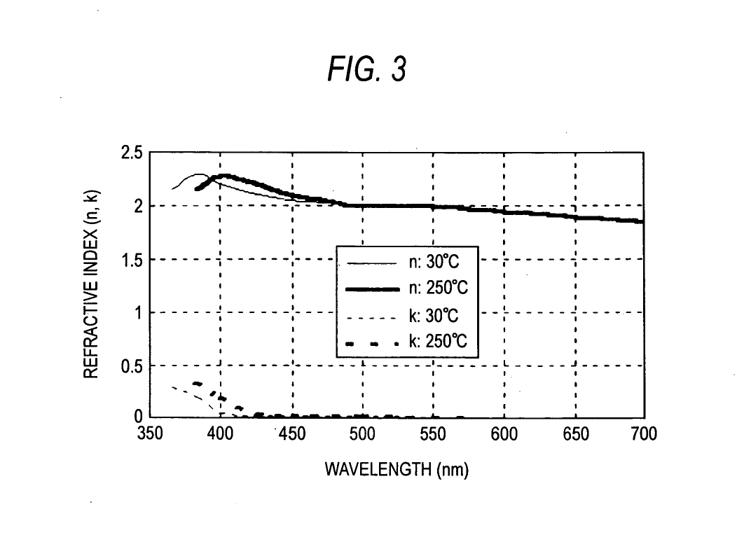

FIG. 3 shows optical constant spectra of a ZnO single film at room temperature (30° C.) and at 250° C. It is apparent that absorption coefficient k increases when the temperature increases from room temperature (30° C.) to 250° C. in a blue-violet wavelength band which will be used in a next-generation optical disc. Accordingly, when ZnO is used as the absorption variation layer, transmittance with respect to the wavelength of reproduction light can be reduced in accordance with the rise in temperature.

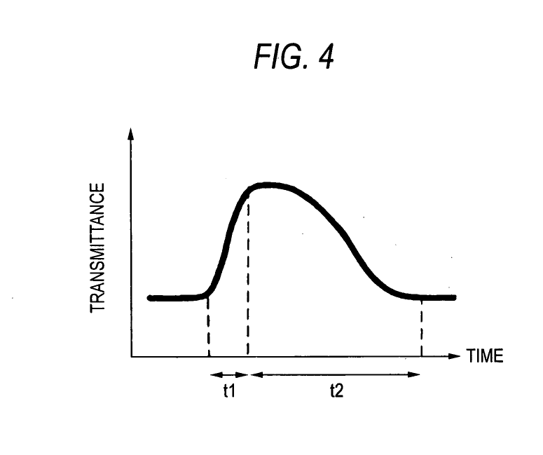

The saturable absorption material is a material which absorbs light when the intensity of incident light is low and which has its absorption coefficient reduced to bring a transmittance increasing phenomenon as the light intensity increases. For example, the saturable absorption material shows a tendency for transmitted light intensity to change in accordance with the time of application of absorption variation light as shown in FIG. 4. Examples of the saturable absorption material include a semiconductor fine particle dispersion film, and an organic pigment such as cyanine pigment or phthalocyanine pigment. Examples of the material of the semiconductor fine particle dispersion film include Cu halide, Ag halide, Cu oxide, AgSe, AgTe, SrTe, SrSe, CaSi, ZnS, ZnTe, CdS, CdSe, CdTe, etc. A transparent dielectric material such as SiO₂, Si₃N₄, Ta₂O₅, TiO₂, ZnS—SiO₂, etc. is used as a base material necessary for dispersing such semiconductor fine particles. For adjustment of the wavelength to bring the saturable absorption effect of the semiconductor fine particle dispersion film, the semiconductor material used may be selected in accordance with the wavelength or the particle size and volume content of fine particles may be adjusted so that the life of de-excitation and the probability of excitation can be controlled.

The photochromic material is a material which produces a photochromic reaction. The photochromic reaction is a reaction in which the state varies in accordance with light. The photochromic reaction is caused not only by isomerization but also by many structural changes such as ring opening-ring closing, ionization, hydrogen migration, etc. Examples of the photochromic material include an azobenzene compound, a stilbene compound, an indigo compound, a thioindigo compound, a spiropyran compound, a spirooxazine compound, a fulgide compound, an anthracene compound, a hydrazone compound, a cinnamic compound, a cyanine pigment, an azo pigment, and a phthalocyanine pigment.

The second substrate 14 is made of a material which can give suitable strength to the optical recording medium. Incidentally, the optical characteristic of the material of the second substrate 14 is not particularly limited. The material of the second substrate 14 may be transparent or opaque. Examples of the material of the substrate include: glass; polycarbonate; amorphous polyolefin; thermoplastic polyimide; thermoplastic resin heat-curable polyimide such as PET, PEN, PES, etc.; heat-curable resin such as ultraviolet-curable acrylic resin, etc.; and combinations thereof. The thickness of the second substrate 14 is not particularly limited but preferably set, for example, to be in a range of from about 0.3 mm to about 1.2 mm.

Though not shown, concavo-convex pits corresponding to recording information and guide grooves are formed in an inner surface of the second substrate 14. The pits or guide grooves are preferably arranged at intervals of a pitch of from about 0.3 μm to about 1.6 μm and with a depth of from about 30 nm to about 200 nm.

Generally, to reproduce the first information layer 11a near to the light incidence side of the single-side double-layer optical recording medium, reproduction light is focused on the first information layer 11a to make access to the first information layer 11a through the first substrate 10. On the other hand, to reproduce the second information layer 11b far from the light incidence side, reproduction light is focused on the second information layer 11b to make access to the information layer 11b through the information layer 11a, the absorption variation layer 12 and the intermediate layer 13 in addition to the first substrate 10.

On this occasion, the absorption variation layer 12 exhibiting light absorption variation is disposed between the first information layer 11a and the second information layer 11b. For this reason, when, for example, the first information layer 11a near to the light incidence side is to be reproduced, reproduction light transmitted through the first information layer 11a is absorbed to the absorption variation layer 12 so that the reproduction light can be prevented from reaching the second information layer 11b far from the light incidence side. Accordingly, increase in bit error rate (bER) can be reduced.

Specifically, when, for example, a thermochromic material is used as the absorption variation layer 12, absorption variation light to reduce reproduction light wavelength transmittance of the absorption variation layer 12 is applied for a predetermined time before reproduction light is applied on a recording track of the first information-layer 11a. After reproduction light wavelength transmittance of the absorption variation layer 12 is reduced in this manner as shown in FIG. 2, reproduction light is applied on the first information layer 11a to make access to the first information layer 11a so that the reproduction light transmitted through the first information layer 11a is absorbed to the absorption variation layer 12. In this manner, the reproduction light can be prevented from reaching the second information layer 11b, so that the value of bER can be reduced.

When a saturable absorption material is used as the absorption variation layer 12, reproduction light applied to reproduce the first information layer 11a cannot be transmitted through the absorption variation layer 12, that is, reproduction light cannot reach the second information layer 11b because the absorption variation layer is initially opaque to the wavelength region of the reproduction light. For this reason, the first information layer 11a can be reproduced when only reproduction light is applied. Accordingly, increase in bit error rate (bER) can be reduced. On the other hand, when the second information layer 11b is to be reproduced, reproduction light must reach the second information layer 11b. Therefore, after absorption variation light is applied on the absorption variation layer 12 to increase transmittance of the absorption variation layer 12 as shown in FIG. 4, reproduction light can be applied on the second information layer 11b to make access to the second information layer 11b.

Also in the case where a photochromic material is used as the absorption variation layer 12, absorption variation light can be applied timely in accordance with the photochromic material of the absorption variation layer to reduce increase in bit error rate (bER) at the time of playing back the first information layer 11a.

A semiconductor laser (LD) generally used for optical recording can be used as the reproduction light source. On the other hand, a semiconductor laser may be used as the absorption variation light source but the wavelength of the absorption variation light source need not be equal to the wavelength of the reproduction light source. The wavelength of light emitted from the reproduction light source may be selected from a range of 380 nm to 780 nm in accordance with the information layers. Also, the wavelength of light emitted from the absorption variation light source may be selected from a range of 380 nm to 780 nm in accordance with material of the absorption variation layer. In the invention, because the area of an absorption variation region need not be limited to an area substantially equal to the area of a reproduction beam, the same effect can be obtained even in the case where absorption variation light with a wider area is induced. For this reason, it is possible to use a light source with a wide application region such as a light-emitting diode, a xenon lamp or a mercury lamp. When a thermochromic material is used as the absorption variation layer, a heat source such as an infrared lamp can be used for inducing variation in absorption.

In the information reproducing method according to this embodiment of the invention, it is preferable that the distance d between the LD for applying reproduction light and the LD for applying absorption variation light is adjusted to satisfy the relation v×t1<d<v×t2 in which v is the rotational linear velocity of the optical recording medium according to this embodiment of the invention, t1 is the time required for completion of absorption variation, t2 is the time required for extinction of absorption variation, and d is the distance between the LD for applying reproduction light and the LD for applying absorption variation light. It is further preferable that the distance d1 of one rotation satisfies the relation d1>v×t2 so that focusing of reproduction light can jump timely from the layer near to the light incidence side to the layer far from the light incidence side.

Although examples concerned with the first embodiment of the invention will be described below, the invention is not limited to the following examples without departing from the gist of the invention.

### EXAMPLE 1

### Single-Side Double-Layer Rewritable Medium

After a 30 nm-thick ZnS—SiO₂ film was formed as an optical interference layer 101a on a 0.6 mm-thick polycarbonate substrate (hereinafter referred to as “first substrate”) 100 having 50 nm-deep grooves arranged at intervals of a track pitch of 0.37 μm by RF magnetron sputtering with 1 kW, a 10 nm-thick Ge₄₀Sb₄Te₅₂Bi₄ film was formed as a recording layer 102 by RF magnetron sputtering with 0.2 kW. After a 10 nm-thick ZnS—SiO₂ film was then formed as an optical interference layer 101b by RF magnetron sputtering with 1 kW, a 10 nm-thick Ag₉₈Pd₁Cu₁ film was formed as a reflection layer 103 by DC magnetron sputtering with 1 kW. Thus, a first information layer 104 was formed on the first substrate 100.

Then, a 200 nm-thick film of ZnO which was a thermochromic material was formed as an absorption variation layer 105 on the first information layer 104 by RF magnetron sputtering with 1 kW.

On the other hand, after a 30 nm-thick ZnS—SiO₂ film was formed as an optical interference layer 107a on a 0.6 mm-thick polycarbonate substrate (hereinafter referred to as “second substrate”) 106 having 50 nm-deep grooves arranged at intervals of a track pitch of 0.37 μm by RF magnetron sputtering with 1 kW, a 100 nm-thick Ag₉₈Pd₁Cu₁ film was formed as a reflection layer 108 by DC magnetron sputtering with 1 kW. After a 10 nm-thick ZnS—SiO₂ film was then formed as an optical interference layer 107b by RF magnetron sputtering with 1 kW, a 10 nm-thick Ge₄₀Sb₄Te₅₂Bi₄ film was formed as a recording layer 109 by RF magnetron sputtering with 0.2 kW. Then, a 10 nm-thick ZnS—SiO₂ film was formed as an optical interference layer 107c by RF magnetron sputtering with 1 kW. Thus, a second information layer 110 was formed on the second substrate 106.

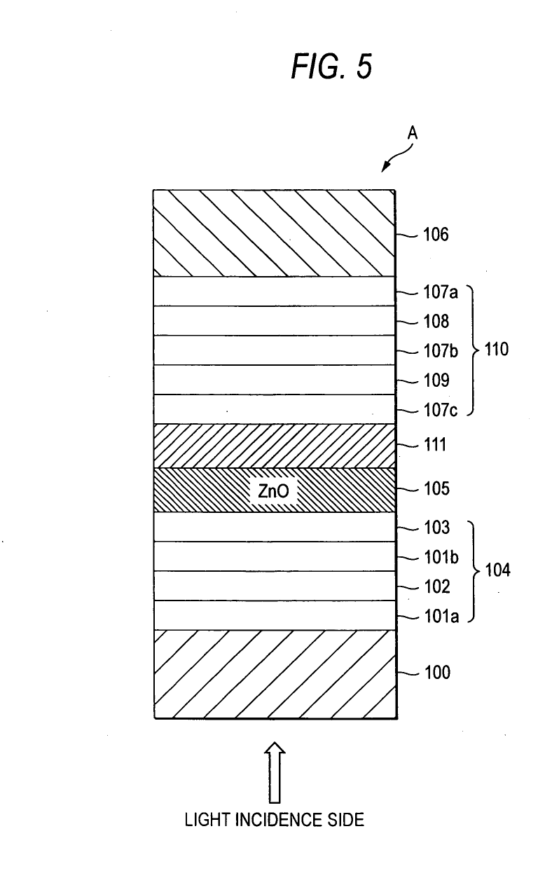

Finally, a 20 μm-thick UV-curable resin as an intermediate layer 111 was applied on the absorption variation layer 105 on the first substrate 100 to stick a coating surface of the UV-curable resin and a film-forming surface of the second information layer 110 to each other to thereby produce a single-side double-layer rewritable optical recording medium (hereinafter referred to as “disc A”) as shown in FIG. 5. Then, the recording layers 102 and 109 of the disc A were crystallized by a laser initialization device.

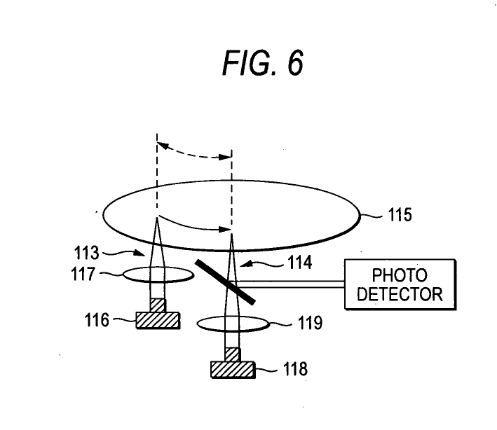

Then, random data were recorded in the recording layers 102 and 109 of the first and second information layers 104 and 110 of the produced disc A respectively independently with recording power of 11 mW and erasing power of 6 mW in accordance with an evaluation condition shown in Table 1. Then, as shown in FIG. 6, after absorption variation light 113 (wavelength 650 nm; an objective lens 117: NA 0.6) from an absorption variation light LD 116 was applied on a measurement subject 115 with 4 mW, reproduction light 114 (wavelength 405 nm; an objective lens 119: NA 0.65) from a reproduction light LD 118 was applied on the measurement subject 115 with 0.8 mW to reproduce the first recording layer 104. In this condition, bit error rate (bER) was measured. Incidentally, the absorption variation light LD 116, the reproduction light LD 118 and the objective lenses 117 and 119 were disposed so that respective focal points came to the same radial position of the disc A when absorption variation light 113 and reproduction light 114 were applied on the measurement subject 115. In the condition that the optical axes of the absorption variation light 113 and reproduction light 114 were shifted by a distance of 0.7 mm (a circumferential angle of 1 degree), the absorption variation light 113 and reproduction light 114 were applied on the measurement subject 115.

TABLE 1

| Light Source Wavelength | 405 | nm |
|---|---|---|
| Objective Lens NA | 0.65 | |
| Linear Velocity | 6.4 | m/s |

### EXAMPLE 2

### Single-Side Double-Layer Rewritable Medium

A first information layer 104 was formed on a first substrate 100 by use of the same material and method as those in Example 1.

Then, a 100 nm-thick ZnSe film of a saturable absorption material with a forbidden band width of 2.8 eV (equivalent to 440 nm) was formed as an absorption variation layer 105 on the first substrate 104 by binary simultaneous RF magnetron sputtering of a ZnSe target and a SiO₂ target in Ar gas with a substrate bias applied for controlling the particle size of ZnSe particles.

The absorption variation layer 105 formed thus was formed so that 50% by volume of ZnSe fine particles with a mean particle size of 5 nm were dispersed in SiO₂. The forbidden band width was slightly widened because ZnSe was provided as fine particles, so that the forbidden band width became 3.1 eV equivalent to energy of light with 405 nm substantially equal to the wavelength of reproduction light. The rising time of the saturable absorption effect was 2 ns. The life of the saturable absorption effect was 30 nm.

Also, the absorption variation layer 105 may be formed so that 5% to 50% by volume of ZnSe fine particles with a mean particle size of 0.1 nm to 50 nm (preferably, 1 nm to 10 nm) are dispersed in SiO₂.

Then, a second information layer 110 was formed on a second substrate 106 by use of the same material and method as those in Example 1.

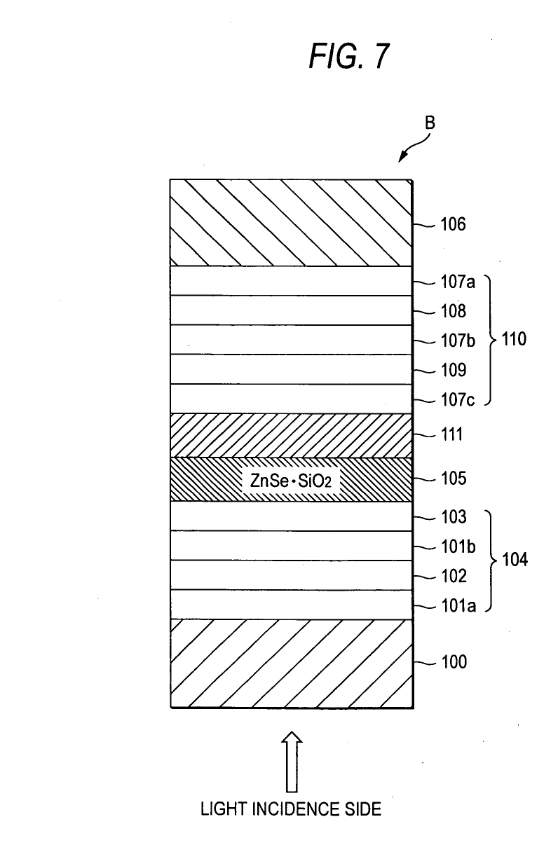

Finally, a 20 μm-thick UV-curable resin as an intermediate layer 111 was applied on the absorption variation layer 105 on the first substrate 100 to stick a coating surface of the UV-curable resin and a film-forming surface of the second information layer 110 to each other to thereby produce a single-side double-layer rewritable optical recording medium (hereinafter referred to as “disc B”) as shown in FIG. 7. Then, the recording layers 102 and 109 of the disc B were crystallized by a laser initialization device.

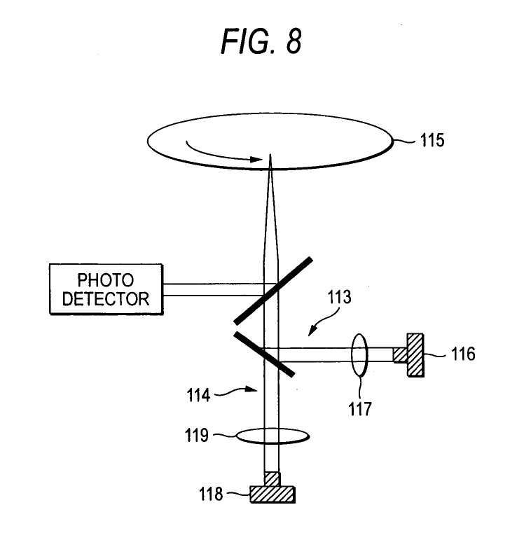

Then, random data were recorded in the recording layers 102 and 109 of the first and second information layers 104 and 110 of the disc B respectively independently with recording power of 10.5 mW and erasing power of 5 mW in accordance with an evaluation condition shown in Table 1. Then, as shown in FIG. 8, only reproduction light 114 (wavelength 405 nm; an objective lens 119: NA 0.65) from a reproduction light LD 118 was applied on a measurement subject 115 with 0.8 mW to reproduce the first recording layer 104. In this condition, bit error rate (bER) was measured.

Then, as shown in FIG. 8, after absorption variation light 113 (wavelength 405 nm; an objective lens 117: NA 0.45) from an absorption variation light LD 116 was applied on the measurement subject 115 with 4 mW, reproduction light 114 (wavelength 405 nm; an objective lens 119: NA 0.65) was applied on the measurement subject 115 with 1.1 mW. Incidentally, absorption variation light 113 was applied before reproduction light 114 was applied while the optical axes of the absorption variation light 113 and reproduction light 114 were made coaxial when the absorption variation light 113 and reproduction light 114 were applied on the measurement subject 115. As a result, the absorption variation layer 105 became transparent, so that the reproduction light 114 can be focused on the second information layer 110.

### EXAMPLE 3

### Single-Side Double-Layer Rewritable Medium

A first information layer 104 was formed on a first substrate 100 by use of the same material and method as those in Example 1.

Then, a 150 nm-thick cyanine pigment layer made of a photochromic material represented by the chemical formula (1) was applied as an absorption variation layer 105 on the first substrate 104 by spin coating.

[Chemical Formula (1)]

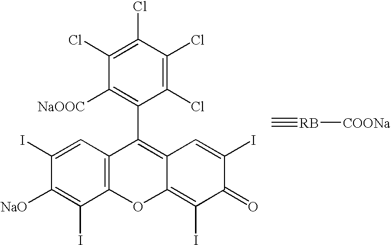

Then, a second information layer 110 was formed on a second substrate 106 by use of the same material and method as those in Example 1.

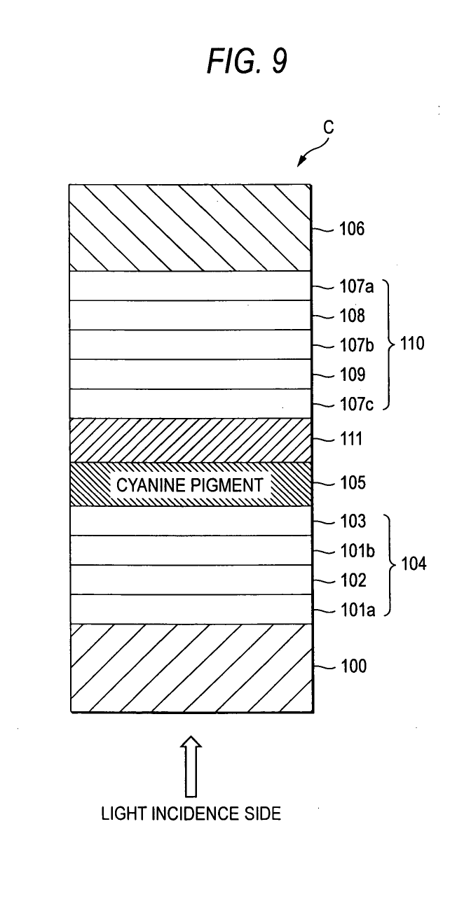

Finally, a 20 μm-thick UV-curable resin as an intermediate layer 111 was applied on the absorption variation layer 105 on the first substrate 100 to stick a coating surface of the UV-curable resin and a film-forming surface of the second information layer 110 to each other to thereby produce a single-side double-layer rewritable optical recording medium (hereinafter referred to as “disc C”) as shown in FIG. 9. Then, the recording layers 102 and 109 of the disc C were crystallized by a laser initialization device.

Then, random data were recorded in the recording layers 102 and 109 of the first and second information layers 104 and 110 of the produced disc C respectively independently with recording power of 10.5 mW and erasing power of 5 mW in accordance with an evaluation condition shown in Table 1. Then, as shown in FIG. 8, only reproduction light 114 (wavelength 405 nm; an objective lens 119: NA 0.65) from a reproduction light LD 118 was applied on a measurement subject 115 with 0.8 mW to reproduce the first recording layer 104. In this condition, bit error rate (bER) was measured.

Then, as shown in FIG. 8, after absorption variation light 113 (wavelength 405 nm; an objective lens 117: NA 0.45) from an absorption variation light LD 116 was applied on the measurement subject 115 with 4 mW, reproduction light 114 (wavelength 405 nm; an objective lens 119: NA 0.65) was applied on the measurement subject 115 with 0.8 mW. As a result, the absorption variation layer 105 became transparent, so that the reproduction light 114 can be focused on the second information layer 110.

### COMPARATIVE EXAMPLE 1

### Single-Side Single-Layer Rewritable Medium

A first information layer 104 was formed on a first substrate 100 by use of the same material and method as those in Example 1.

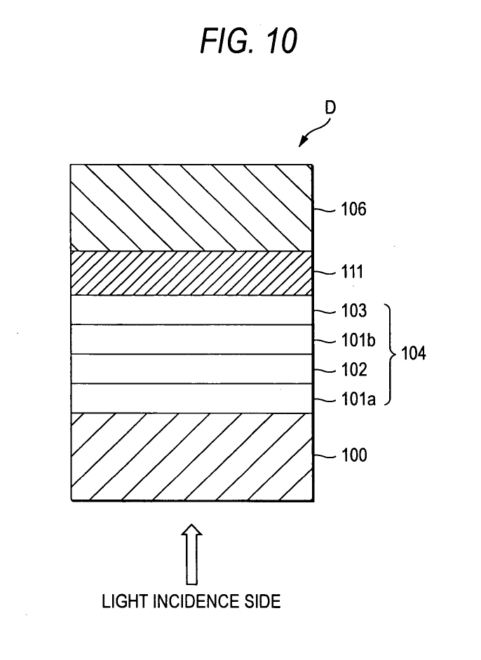

Then, a 20 mm-thick UV-curable resin as an intermediate layer 111 was applied on the first information layer 104 to stick the first substrate 100 to a 0.6 mm-thick polycarbonate substrate 106 (second substrate) having 50 nm-deep grooves arranged at intervals of a track pitch of 0.37 μm. Thus, a single-side single-layer rewritable recording medium (hereinafter referred to as “disc D”) was produced as shown in FIG. 10.

Then, random data were recorded in the recording layer 102 of the first information layer 104 of the produced disc D with recording power of 10.5 mW and erasing power of 5 mW in accordance with an evaluation condition shown in Table 1. Then, as shown in FIG. 8, only reproduction light 114 (wavelength 405 nm; an objective lens 119: NA 0.65) from a reproduction light LD 118 was applied on a measurement subject 115 with 0.8 mW to reproduce the first recording layer 104. In this condition, bit error rate (bER) was measured.

### COMPARATIVE EXAMPLE 2

### Single-Side Single-Layer Rewritable Medium

A second information layer 110 was formed on a second substrate 106 by use of the same material and method as those in Example 1.

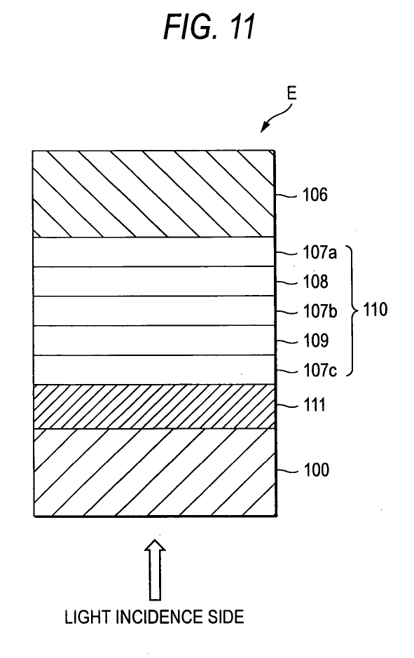

Then, a 20 mm-thick UV-curable resin as an intermediate layer 111 was applied on the second information layer 110 to stick the second substrate 106 to a 0.6 mm-thick polycarbonate substrate 100 (first substrate) having 50 nm-deep grooves arranged at intervals of a track pitch of 0.37 μm. Thus, a single-side single-layer rewritable recording medium (hereinafter referred to as “disc E”) was produced as shown in FIG. 11.

Then, random data were recorded in the second information layer 110 of the produced disc E with recording power of 10.5 mW and erasing power of 5 mW in accordance with an evaluation condition shown in Table 1. Then, as shown in FIG. 8, only reproduction light 114 (wavelength 405 nm; an objective lens 119: NA 0.65) from a reproduction light LD 118 was applied on a measurement subject 115 with 0.8 mW to reproduce the second recording layer 110. In this condition, bit error rate (bER) was measured.

### COMPARATIVE EXAMPLE 3

### Single-Side Double-Layer Rewritable Medium

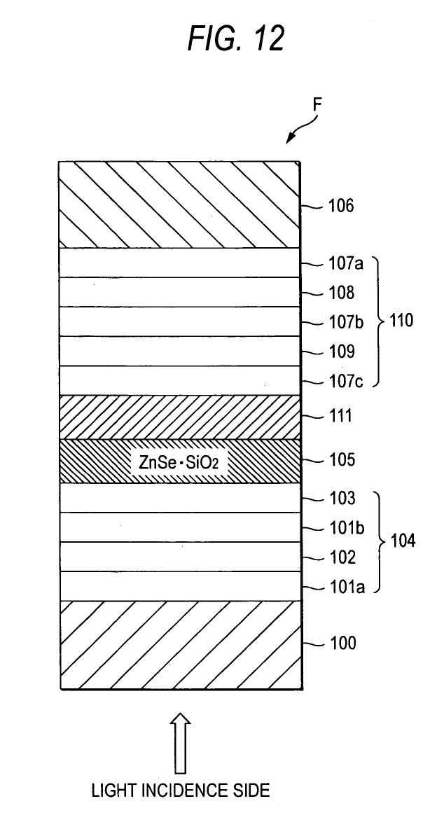

A single-side double-layer rewritable optical recording medium (hereinafter referred to as “disc F”) as shown in FIG. 12 was produced by use of the same material and method as in Example 1 except that the absorption variation layer 105 was not formed.

Then, random data were recorded in the recording layers 102 and 109 of the first and second information layers 104 and 110 of the produced disc F respectively independently with recording power of 11 mW and erasing power of 6 mW in accordance with an evaluation condition shown in Table 1. Then, as shown in FIG. 8, only reproduction light 114 (wavelength 405 nm; an objective lens 119: NA 0.65) from a reproduction light LD 118 was applied on a measurement subject 115 with 0.8 mW to reproduce the first recording layer 104. In this condition, bit error rate (bER) was measured.

Table 2 shows results of evaluation of bit error rate (bER) in Examples and Comparative Examples. In comparison between bit error rates (bER) in discs D, E and F, the bit error rate (bER) in the disc D or E having one information layer was about 10⁻⁵ whereas the bit error rate (bER) in the disc F having two information layers was reduced to about 10⁻³ when the first information layer 104 was reproduced. On the other hand, the bit error rate (bER) in the disc A, B or C having the absorption variation layer 105 provided between the first and second information layers 104 and 110 was about 10⁻⁵, that is, the disc A, B or C exhibited good disc characteristic of the same level as the disc D or E having one information layer.

TABLE 2

| | | Number of | | |
|---|---|---|---|---|
| | | Information | Reproduction | |
| | Disc | Layers | layer | bER |
| Example 1 | A | Two | First | 6.0 × 10⁻⁵ |
| | | | Information | |
| | | | Layer | |
| Example 2 | B | Two | First | 4.8 × 10⁻⁵ |
| | | | Information | |
| | | | Layer | |
| Example 3 | C | Two | First | 5.5 × 10⁻⁵ |
| | | | Information | |
| | | | Layer | |
| Comparative | D | One | First | 1.2 × 10⁻⁵ |
| Example 1 | | | Information | |
| | | | Layer | |
| Comparative | E | One | Second | 3.0 × 10⁻⁵ |
| Example 2 | | | Information | |
| | | | Layer | |
| Comparative | F | Two | First | 5.0 × 10⁻³ |
| Example 3 | | | Information | |
| | | | Layer | |

### Second Embodiment

### Single-Side Double-Layer Read-Only Medium

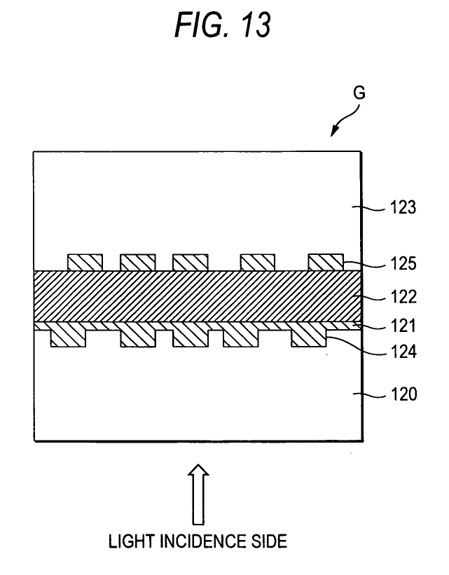

As shown in FIG. 13, an optical recording medium according to a second embodiment of the invention is formed as a single-side double-layer read-only optical recording medium which includes a first substrate 120, an absorption variation layer 121, an intermediate layer 122 and a second substrate 123 laminated successively when viewed from a light incidence side. First pits 124 in which information is recorded are formed in the first substrate 120. The absorption variation layer 121 is disposed on the first substrate 120 inclusive of the first pits 124. Second pits 125 in which information is recorded are formed in the second substrate 123 similarly to the first substrate 120.

Incidentally, the characteristics, materials, etc. of the first substrate 120, the absorption variation layer 121, the intermediate layer 122 and the second substrate 123 are the same as those of the first substrate 10, the absorption variation layer 12, the intermediate layer 13 and the second substrate 14 in the first embodiment, and the description thereof will be omitted.

The first pits 124 or second pits 125 mean so-called “depressed portions” formed in each substrate. The first and second pits 124 and 125 have a so-called recording layer function for recording data such as video data and audio data on the basis of arrangement of “depressed portions”. When reproduction light is applied on the depressed portions, change in reflected light generated in accordance with the presence/absence of the depressed portions is grasped to reproduce data such as video data and audio data.

Also in the read-only recording medium having pit layers, reproduction light transmitted through the first pits 124 is absorbed to the absorption variation layer 121 so that the reproduction light can be prevented from reaching the second pits 125 far from the light incidence side when the first bits 124 near to the light incidence side are to be reproduced, because the absorption variation layer bringing change in light absorption is disposed between the recording layers in which pits are formed. For this reason, increase in bit error rate (bER) can be reduced.

Although examples concerned with the second embodiment of the invention will be described below, the invention is not limited to the following examples without departing from the gist of the invention.

### EXAMPLE 4

First pits 124 were formed by injection molding on a surface of a 0.6 mm-thick polycarbonate substrate (hereinafter referred to as “first substrate”) 120 having 50 nm-deep grooves arranged at intervals of a track pitch of 0.37 μm. Then, a 10 nm-thick silver alloy film was first formed on the first substrate 120. A 100 nm-thick ZnO film made of a thermochromic material was then formed to prepare an absorption variation layer 121.

Further, second pits 125 were formed by injection molding on a surface of a 0.6 mm-thick polycarbonate substrate (hereinafter referred to as “second substrate”) 123 having 50 nm-deep grooves arranged at intervals of a track pitch of 0.37 Wn. Then, a 100 nm-thick silver alloy film was formed on the second substrate 123.

Finally, a 20 μm-thick UV-curable resin as an intermediate layer 122 was applied on the absorption variation layer 121 on the first substrate 120 to stick a coating surface of the UV-curable resin and a silver alloy film-forming surface of the second pits 125 to each other to thereby produce a single-side double-layer read-only recording medium (hereinafter referred to as “disc G”) as shown in FIG. 13.

Then, absorption variation light 113 and reproduction light 114 were applied in the same manner as in Example 1 to reproduce the first pits 124 of the produced disc G. In this condition, bit error rate (bER) was measured.

### COMPARATIVE EXAMPLE 4

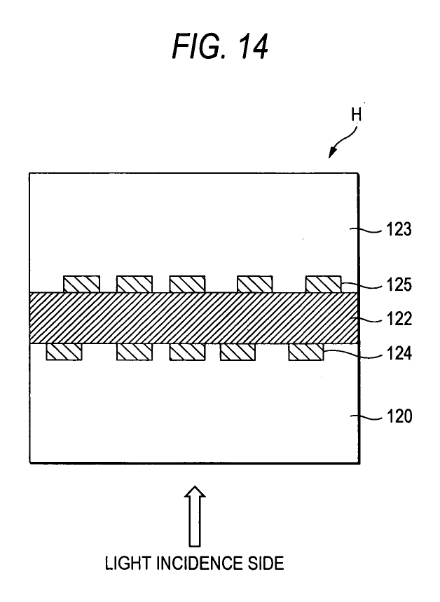

A single-side double-layer read-only recording medium (hereinafter referred to as “disc H”) as shown in FIG. 14 was produced by use of the same material and method as those in Example 4 except that the absorption variation layer 121 was not formed as a ZnO film made of a thermochromic material on the first substrate 120.

Then, only reproduction light 114 (wavelength 405 nm; an objective lens 119: NA 0.65) was applied with 0.8 mW to reproduce the first pits 124. In this condition, bit error rate (bER) was measured.

Table 3 shows results of evaluation of bit error rate (bER) in Example 4 and Comparative Example 4. The bit error rate (bER) in the disc H having no absorption variation layer 121 was about 10⁻³ whereas the bit error rate (bER) in the disc G having the absorption variation layer 121 was about 10⁻⁵, that is, the disc G exhibited good disc characteristic.

TABLE 3

| | | Number of | | |
|---|---|---|---|---|
| | | Information | Reproduction | |
| | Disc | Layers | layer | bER |
| Example 4 | G | Two | First Pits | 2.0 × 10⁻⁵ |
| Comparative | H | Two | First Pits | 1.0 × 10⁻³ |
| Example 4 | | | | |

### Third Embodiment

### Single-Side Triple-Layer Read-Only Medium

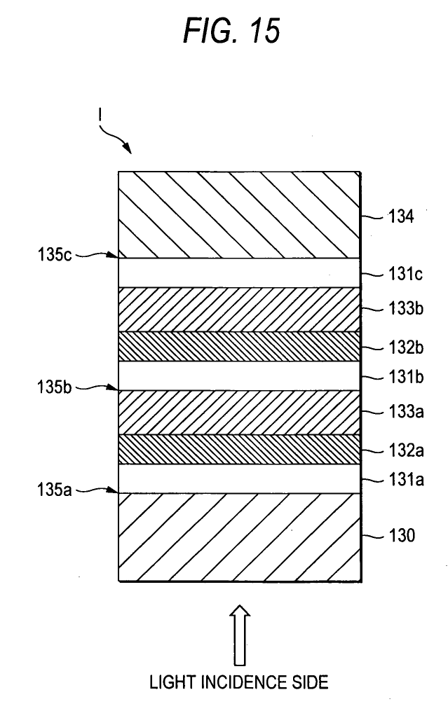

As shown in FIG. 15, an optical recording medium according to a third embodiment of the invention is formed as a single-side triple-layer read-only optical recording medium which includes a first substrate 130, a first reflection film 131a, a first absorption variation layer 132a, a first intermediate layer 133a, a second reflection layer 131b, a second absorption variation layer 132b, a second intermediate layer 133b, a third reflection layer 131c and a second substrate 134 laminated successively when viewed from a light incidence side. Though not shown, a first recording layer 135a, a second recording layer 135b and a third recording layer 135c are formed on the first substrate 130, the first intermediate layer 133a and the second substrate 134 respectively.

Incidentally, the characteristics, materials, etc. of the substrates 130 and 134, the reflection layers 131a, 131b and 131c, the absorption variation layers 132a and 132b and the intermediate layers 133a and 133b are the same as those of the substrates 10 and 14, the reflection layers 17, the absorption variation layer 12 and the intermediate layer 13 in the first embodiment, and the description thereof will be omitted.

Also in the recording medium having recording layers formed as described above, reproduction light transmitted through the first recording layer 135a is absorbed to the first absorption variation layer 132a so that the reproduction light can be prevented from reaching the second recording layer 135b secondly near to the light incidence side when the first recording layer 135a is to be reproduced, because the absorption variation layers bringing change in light absorption are disposed between the recording layers. For this reason, increase in bit error rate (bER) can be reduced. Moreover, reproduction light transmitted through the second recording layer 135b is absorbed to the second absorption variation layer 132b so that the reproduction light can be prevented from reaching the third recording layer 135c thirdly near to the light incidence side when the second recording layer 135b secondly near to the light incidence side is to be reproduced. For this reason, increase in bit error rate (bER) can be reduced.

Although an example concerned with the third embodiment of the invention will be described below, the invention is not limited to the following example without departing from the gist of the invention.

### EXAMPLE 5

A first recording layer 135a was formed by injection molding on a surface of a 0.6 mm-thick polycarbonate substrate (hereinafter referred to as “first substrate”) 130 having 50 nm-deep grooves arranged at intervals of a track pitch of 0.37 μm. Then, a 2 nm-thick silver alloy film was formed as a reflection film 131a on the first recording layer 135a. A 50 nm-thick semiconductor fine particle dispersion film was further formed as a first absorption variation layer 132a which was formed so that 50% by volume of AlSb fine particles with a mean particle size of 10 nm were dispersed in a SiO₂ matrix. Incidentally, the forbidden band width of AlSb was 1.55 eV (equivalent to a wavelength of 800 nm).

Also, the first absorption variation layer 132a may be formed so that 5% to 50% by volume of AlSb fine particles with a mean particle size of 0.1 nm to 50 nm (preferably, 1 nm to 10 nm) are dispersed in a SiO₂ matrix.

Then, a 20 μm-thick UV-curable resin as a first intermediate layer 133a was applied on the first absorption variation layer 132a on the first substrate 130. In the other process, a second recording layer 135b was formed by injection molding on a 1.1 mm-thick acrylic substrate. While the surface of the UV-curable resin and the second recording layer 135b formed on the acrylic substrate were arranged so as to be put together and pressurized uniformly from opposite sides, UV light was applied on the UV-curable resin to cure the UV-curable resin to thereby remove the acrylic substrate. Thus, the second recording layer 135b was formed on the UV-curable resin. A 2 nm-thick silver alloy film was further formed as a reflection film 131b on the second recording layer 135b. A 50 nm-thick semiconductor fine particle dispersion film was further formed as a second absorption variation layer 132b which was formed so that 50% by volume of CdSe fine particles with a mean particle size of 15 nm were dispersed in a SiO₂ matrix. Incidentally, the forbidden band width of CdSe was 1.84 eV (equivalent to a wavelength of 674 nm).

A third recording layer 135c was formed by injection molding on a surface of a 0.6 mm-thick polycarbonate substrate (hereinafter referred to as “second substrate”) 134 having 50 nm-deep grooves arranged at intervals of a track pitch of 0.37 μm. Then, a 50 nm-thick silver alloy film was formed as a third reflection layer 131c on the third recording layer 135c.

Finally, a 20 μm-thick UV-curable resin as a second intermediate layer 133b was applied on the second absorption variation layer 132b on the first substrate 130 to stick a coating surface of the UV-curable resin and a film-forming surface of the third reflection layer 131c on the second substrate 134 to each other to thereby produce a single-side triple-layer read-only recording medium (hereinafter referred to as “disc I”) as shown in FIG. 15.

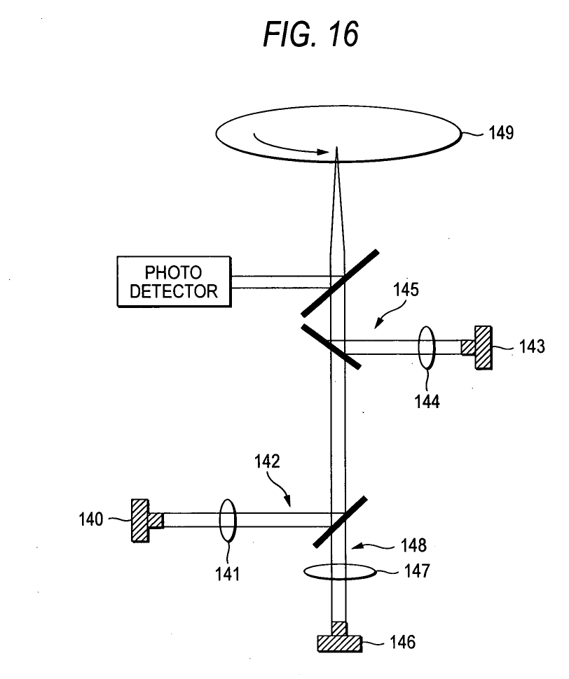

The disc I was reproduced by use of LDs 140 and 143 for applying absorption variation light with wavelengths of 780 nm and 650 nm and an LD 146 for applying reproduction light with a wavelength of 405 nm. FIG. 16 shows an information reproducing method in this example. First, the reproduction light LD 146 was turned on. In the condition that reproduction light 148 (wavelength 405 nm; an objective lens 147: NA 0.65) was focused on the first recording layer 135a, the first recording layer 135a was read by the reproduction light 148 with power of 0.6 mW. As a result, because the semiconductor fine particle dispersion film of each of the first and second absorption variation layers 132a and 132b provided in the medium was not excited, transmittance of each film was so low that the first recording layer 135a could be read with high bit error rate (bER) without influence of the other recording layers 135b and 135c.

Then, the absorption variation light LD 140 was turned on to turn on the absorption variation light source with a wavelength of 780 nm to thereby apply absorption variation light 142 (wavelength 780 nm; an objective lens 141: NA 0.6) on a measurement subject 149 with power of 4.0 mW. As a result, the semiconductor fine particle dispersion film which was the first absorption variation layer 132a between the first and second recording layers 135a and 135b became so transparent that reproduction light could be focused on the second recording layer 135b. Then, the reproduction light LD 146 was turned on. In the condition that reproduction light 148 (wavelength 405 nm; an objective lens 147: NA 0.65) was focused on the second recording layer 135b, the second recording layer 135b was read by the reproduction light 148 with power of 1.0 mW. As a result, because the semiconductor fine particle dispersion film of the second absorption variation layer 132b provided in the measurement subject 149 was not excited, transmittance of the second absorption variation layer 132b was so low that the second reading layer 135b could be read with high bit error rate (bER) without influence of the third recording layer 135c.

Finally, the absorption variation light LD 143 was turned on to apply absorption variation light 145 (wavelength 650 nm; an objective lens 144: NA 0.6) on the medium with power of 4.5 mW. As a result, the semiconductor fine particle dispersion film which was the first absorption variation layer 132a between the first and second recording layers 135a and 135b and the semiconductor fine particle dispersion film which was the second absorption variation layer 132b between the second and third recording layers 135b and 135c became so transparent that reproduction light could be focused on the third recording layer 135c.

### Fourth Embodiment

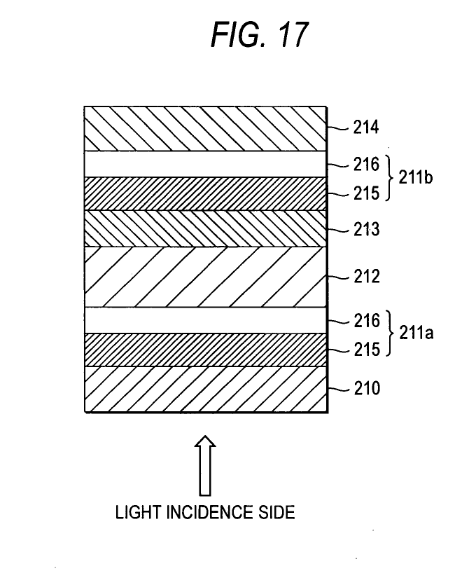

As shown in FIG. 17, an optical recording medium according to a fourth embodiment of the invention is formed as a single-side double-layer write-once read-many optical recording medium. The optical recording medium includes a first substrate 210, a first information layer 211a, an absorption variation layer 212, an intermediate layer 213, a second information layer 211b and a second substrate 214 laminated successively when viewed from a light incidence side. The first information layer 211a has an organic dye layer 215 and a reflection layer 216 laminated successively when viewed from the light incidence side. The second information layer 211b has an organic dye layer 215 and a reflection layer 216 laminated successively when viewed from the light incidence side.

Since each of the first and second information layers 211a and 211b includes the organic dye layer 215, the optical recording medium shown in FIG. 17 is of a so-called “write-once read-many (WORM).” Except the structures of the first and second information layers 211a and 211b, the optical recording medium according to this embodiment is similar to one according to the first embodiment. Therefore, a method for reproducing information recorded in the optical recording medium according to this embodiment may also be similar to the first embodiment. For example, the optical system shown in FIG. 6 may be used to reproduce the information recorded in the optical recording medium according to this embodiment.

What is claimed is:

1. An optical recording medium comprising:
a plurality of information layers in which information is recorded; and
an absorption variation layer disposed between respective two adjacent information layers, light transmittance of the absorption variation layer being varied in accordance with light applied thereto.

2. The optical recording medium according to claim 1, wherein:
each information layer comprises:
a recording layer into which the information is recorded;
a pair of dielectric layers, the recording layer disposed between the dielectric layers; and
a reflection layer, one of the dielectric layers disposed between the reflection layer and the recording layer.

3. The optical recording medium according to claim 1, wherein each information layer comprises:
an organic dye layer into which the information is recorded; and
a reflection layer disposed on the dye layer.

4. The optical recording medium according to claim 1, wherein each information layer comprises a recording layer, a plurality of pits formed in a surface of each recording layer.

5. The optical recording medium according to claim 1, wherein:
the information layers comprise first, second and third information layers, and
the absorption variation layer comprises first and second absorption variation layers, the first absorption variation layer disposed between the first and second information layers, the second absorption variation layer disposed between the second and third information layers.

6. The optical recording medium according to claim 1, wherein the absorption variation layer comprises a material exhibiting thermochromism.

7. The optical recording medium according to claim 6, wherein the material exhibiting thermochromism comprises one selected from the group consisting of ZnO, SnO₂, CeO₂, NiO₂, In₂O₃, TiO₂, Ta₂O₅, VO₂ and SrTiO₃.

8. The optical recording medium according to claim 6, wherein the material exhibiting thermochromism has 375 nm at room temperature in an absorption edge wavelength.

9. The optical recording medium according to claim 1, wherein the absorption variation layer comprises a material exhibiting a saturable absorption effect.

10. The optical recording medium according to claim 9, wherein the material exhibiting the saturable absorption effect comprises one of a semiconductor fine particle dispersion film and an organic pigment.

11. The optical recording medium according to claim 9, wherein the material exhibiting the saturable absorption effect comprises one selected from the group consisting of Cu halide, Ag halide, Cu oxide, AgSe, AgTe, SrTe, SrSe, CaSi, ZnS, ZnTe, CdS, CdSe and CdTe.

12. The optical recording medium according to claim 9, wherein the material exhibiting the saturable absorption effect comprises ZnSe having 0.1 nm to 50 nm in a mean particle size, ZnSe dispersed in one selected from the group consisting of SiO₂, Si₃N₄, Ta₂O₅, TiO₂ and ZnS—SiO₂ to have 5% to 50% in percent per volume.

13. The optical recording medium according to claim 9, wherein the material exhibiting the saturable absorption effect comprises AlSb having O.lnm to 50 nm in a mean particle size, ZnSe dispersed in one selected from the group consisting of SiO₂, Si₃N₄, Ta₂O₅, TiO₂ and ZnS—SiO₂ to have 5% to 50% in percent per volume.

14. The optical recording medium according to claim 1, wherein the absorption variation layer comprises a material exhibiting photochromism.

15. A method for reproducing information recorded in the optical recording medium according to claim 1, the method comprising:
applying absorption variation light onto the optical recording medium to change the light transmittance of the absorption variation layer; and
applying reproduction light to reproduce the information recorded in the information layers of the optical recording medium.

16. The method according to claim 15, further comprising:
rotating the optical recording medium.

17. An optical information reproducing apparatus comprising:
the optical recording medium comprising:
a plurality of information layers in which information is recorded; and
an absorption variation layer disposed between two adjacent information layers, light transmittance of the absorption variation layer being varied in accordance with light applied thereto;
a first light emission device configured to emit absorption variation light onto the optical recording medium; and
a second light emission device configured to emit reproduction light.

18. The apparatus according to claim 17, further comprising:
a first optical system into which the absorption variation light emitted from the first light emission device enters, the first optical system configured to apply the absorption variation light to the optical recording medium; and
a second optical system into which the reproduction light emitted from the second light emission device enters, the second optical system configured to apply the reproduction light to the optical recording medium, a light axis of the absorption variation light coming out from the first optical system being different from that of the reproduction light coming out from the second optical system.

19. The apparatus according to claim 18, wherein:
the absorption light variation light has a first wavelength in a range of 380 nm to 780 nm, and
the reproduction light has a second wavelength in a range of 380 nm to 780 nm, the first wavelength equal to the second wavelength.

20. The apparatus according to claim 18, wherein:
the absorption light variation light has a first wavelength in a range of 380 nm to 780 nm, and
the reproduction light has a second wavelength in a range of 380 nm to 780 nm, the firstwavelength different from the second wavelength.

21. The apparatus according to claim 17, further comprising:
a first optical system into which the absorption variation light emitted from the first light emission device enters, the first optical system configured to apply the absorption variation light to the optical recording medium; and
a second optical system into which the reproduction light emitted from the second light emission device enters, the second optical system configured to apply the reproduction light to the optical recording medium, a light axis of the absorption variation light coming out from the first optical system coinciding with that of the reproduction light coming out from the second optical system.

22. The apparatus according to claim 21, wherein:
the absorption. light variation light has a first wavelength in a range of 380 nm to 780 nm, and the reproduction light has a second wavelength in a range of 380 nm to 780 nm, the first wavelength equal to the second wavelength.

23. The apparatus according to claim 22, wherein:
the absorption light variation light has a first wavelength in a range of 380 nm to 780 nm, and
the reproduction light has a second wavelength in a range of 380 nmto 780 nm, the first wavelength different from the second wavelength.
